(19) United States
(12) Patent Application Publication
(10) Pub. No.: US 2026/0141171 A1
(43) Pub. Date: May 21, 2026

(54) INFORMATION PROCESSING METHOD AND APPARATUS, ELECTRONIC DEVICE, AND STORAGE MEDIUM

(71) Applicant: Beijing Zitiao Network Technology Co., Ltd., Beijing (CN)

(72) Inventors: Bo XIE, Beijing (CN); Ziqing ZHOU, Beijing (CN); Zhendong JIANG, Beijing (CN)

(21) Appl. No.: 19/123,386

(22) PCT Filed: Sep. 21, 2023
(86) PCT No.: PCT/CN2023/120409

§ 371 Date: Apr. 22, 2025

(30) Foreign Application Priority Data
Oct. 31, 2022 (CN) 202211351885.0

(51) Int. Cl. G06F 40/186; H04L 51/02

(52) U.S. Cl. CPC G06F 40/186; H04L 51/02

(57) ABSTRACT

An information processing method and apparatus, an electronic device, and a storage medium. The method includes: in response to generating, in a first group, first information mentioning a chat robot, determining a first topic in which the first information is located, wherein the first information is topic information or topic reply information; and generating a corresponding first record in a first document according to the first topic in which the first information is located, wherein the first group is associated with the first document.

### CROSS-REFERENCE TO RELATED APPLICATIONS

The present disclosure claims the priority to the Chinese patent application No. 202211351885.0 entitled “INFORMATION PROCESSING METHOD AND APPARATUS, TERMINAL, AND STORAGE MEDIUM” and filed on Oct. 31, 2022, the disclosure of which is incorporated by reference herein in its entirety.

### TECHNICAL FIELD

The present disclosure relates to the field of computer technology, and in particular, to a computer method and apparatus, an electronic device, and a storage medium.

### BACKGROUND

A communication client, such as communication software, or an integrated platform with a communication function, is used for communication with other users, the communication client having a communication group therein.

### SUMMARY

The present disclosure provides an information processing method and apparatus, an electronic device, and a storage medium.

The present disclosure adopts the following technical solutions.

In some embodiments, the present disclosure provides an information processing method, comprising:
in response to generating first information which mentions a chatbot in a first group, determining a first topic in which the first information is located, wherein the first information is topic information or topic reply information; and
generating a corresponding first record in a first document according to the first topic in which the first information is located,
wherein the first group is associated with the first document.

In some embodiments, the present disclosure provides an information processing apparatus, comprising:
a detecting unit configured to, in response to generating first information which mentions a chatbot in a first group, determine a first topic in which the first information is located, wherein the first information is topic information or topic reply information; and
a processing unit configured to generate a corresponding first record in a first document according to the first topic in which the first information is located,
wherein the first group is associated with the first document.

In some embodiments, the present disclosure provides an electronic device, comprising: at least one memory and at least one processor,
wherein the memory is configured to store program codes, and the processor is configured to call the program codes stored in the memory to perform the method described above.

In some embodiments, the present disclosure provides a non-transitory computer-readable storage medium for storing program codes which, when executed by a computer, cause the computer to perform the method described above.

In some embodiments, the present disclosure provides a computer program which, when executed by a processor, implements the method described above.

### BRIEF DESCRIPTION OF THE DRAWINGS

The above and other features, advantages, and aspects of embodiments of the present disclosure will become more apparent by combining the accompanying drawings and referring to the following DETAILED DESCRIPTION. Throughout the drawings, the same or similar reference numbers refer to the same or similar elements. It should be understood that the drawings are schematic and that components and elements are not necessarily drawn to scale.

FIG. 1 is a flow diagram of an information processing method according to an embodiment of the present disclosure.

FIG. 2 is a schematic diagram of a record in a first document according to an embodiment of the present disclosure.

FIG. 3 is a schematic processing flow diagram after information is generated in a first group according to an embodiment of the present disclosure.

FIG. 4 is a schematic flow diagram of an information processing method according to an embodiment of the present disclosure.

FIG. 5 is a partial schematic flow diagram of an information processing method according to an embodiment of the present disclosure.

FIG. 6 is a schematic interaction diagram of an information processing method according to an embodiment of the present disclosure.

FIG. 7 is a schematic structural diagram of an electronic device according to an embodiment of the present disclosure.

### DETAILED DESCRIPTION

Embodiments of the present disclosure will be described in more detail below with reference to the accompanying drawings. While certain embodiments of the present disclosure are shown in the drawings, it should be understood that the present disclosure may be implemented in various forms and should not be construed as limited to the embodiments set forth herein, which are provided for a more complete and thorough understanding of the present disclosure instead. It should be understood that the drawings and the embodiments of the present disclosure are for exemplary purposes only and are not intended to limit the scope of protection of the present disclosure.

It should be understood that various steps recited in method embodiments of the present disclosure may be performed in an order, and/or performed in parallel. Moreover, the method embodiments may include additional steps and/or omit performing the illustrated step(s). The scope of the present disclosure is not limited in this respect.

The term “include” and variations thereof used herein are intended to be open-ended, i.e., “including but not limited to”. The term “based on” is “at least partially based on”. The term “one embodiment” means “at least one embodiment”; the term “another embodiment” means “at least one other embodiment”; and the term “some embodiments” means “at least some embodiments”. Definitions related to other terms will be given in the following description.

It should be noted that the concepts “first”, “second”, and the like mentioned in the present disclosure are only used for distinguishing different devices, modules, or units, and are not used for limiting the order or interdependence of functions performed by the devices, modules, or units.

It should be noted that the modification of “a” mentioned in the present disclosure is intended to be illustrative rather than restrictive, and that those skilled in the art should appreciate that it should be understood as “one or more” unless otherwise explicitly stated in the context.

Names of messages or information exchanged between a plurality of devices in the embodiments of the present disclosure are for illustrative purposes only, and are not intended to limit the scope of the messages or information.

The present disclosure provides an information processing method, comprising: in response to generating first information which mentions a chatbot in a first group, determining a first topic in which the first information is located, wherein the first information is topic information or topic reply information; and generating a corresponding first record in a first document according to the first topic in which the first information is located, wherein the first group is associated with the first document. In the embodiments of the present disclosure, non-full information synchronization recording is achieved, such that a user can select information to be recorded in the first document according to his own need.

The solutions provided in the embodiments of the present application will be described in detail below in conjunction with the accompanying drawings.

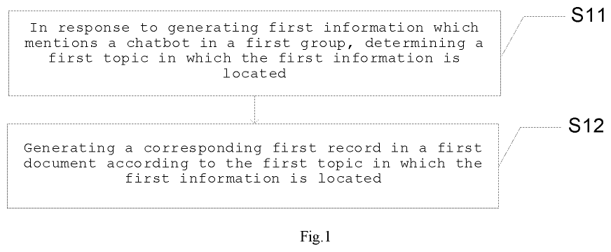

As shown in FIG. 1, it is a flow diagram of an information processing method according to an embodiment of the present disclosure, comprising the following steps.
S11: in response to generating first information which mentions a chatbot in a first group, determining a first topic in which the first information is located. In some embodiments, the method provided in the present disclosure may be used in a communication client, which may be communication software or a collaboration platform where a communication function is integrated. A communication object in the communication client may include an individual object and a group object, and the first group may be a group with three or more members. The first information is communication information sent by the members in the first group. The chatbot may be taken as a member in the first group. There may be various manners of mentioning the chatbot, for example, by “@chatbot” in the first information. In some embodiments, the first information is topic information or topic reply information. The topic information is different from a general instant messaging message. The first group may be a topic group where only a topic and reply information to the topic can be posted, or a group where topic and non-topic instant messaging messages can be posted. In some embodiments, the reply information of the topic information (i.e. the topic reply information) is presented in a reply area for the topic information, so that all the reply information can be viewed by viewing the topic information, without searching for related reply information in the communication group; and instant messaging message in the topic group is all displayed in a form of topic information and topic reply information, rather than in a form of ordinary information. A difference between the topic information and the general instant messaging message includes: the topic information and the topic reply information being presented in a form of aggregated information. In the present disclosure, the first topic in which the first information is located refers to a first topic related to the first information. If the first information is the topic information, the first topic is the first information, and if the first information is the topic reply information, the first topic is topic information to which the first information replies.
S12: generating a corresponding first record in a first document according to the first topic in which the first information is located.

In some embodiments, after it is detected that the first information is generated in the first group, the first document is determined, the first group being associated with the first document. The first document may be an online document, for example, a group document for the first group, and the first document may be a text document or a table document, and in order to conveniently record information, the first document is an online table document, for example, a database table document. When the first record is generated according to the first topic, it is possible to determine preset data to be acquired in the first record, then analyze the first topic and the topic reply information of the first topic and acquire the data to be acquired, and then record the data in the first document; and, the first record may have one or more fields, and content recorded in the fields of the first record may include a poster of the first topic, content information of the first topic, a creation time of the first topic, and other related information. In some embodiments of the present disclosure, the first record has an association relation with the first topic, rather than just recording one record in the first document; and the association relation is established between the two; in some embodiments, the first document may be opened and the first record is positioned by performing a preset operation event on the first topic, and in some embodiments, when the first topic is updated, the first record is updated correspondingly. In other embodiments, the first topic may be positioned by performing an operation on the first record.

In some embodiments, unlike a conventional excel or spreadsheet, each column of data in a database table is configured with one data type which may also be understood as a field type, and data inputted in cells of the column must correspond to the data type; and, each cell, when created, is assigned a data type which corresponds to a field of a title row for each column of cell data.

In some embodiments of the present disclosure, considering that important information in the first group needs to be recorded, or in order to make it convenient for a user to search for the information, the first record may be generated in the first document by mentioning the chatbot when the first information is posted, and for information where the chatbot is not mentioned, a corresponding record may not be generated, that is, non-full information synchronization recording is achieved, such that the user may select information to be synchronized into the first document according to his own need. In addition, when the topic information is posted, if the chatbot is not mentioned, a corresponding record can be generated in the first document by mentioning the chatbot in the topic reply information, thereby improving the use experience of the user.

In some embodiments of the present disclosure, the generating a corresponding first record in a first document according to the first topic in which the first information is located comprises: creating the first record in the first document, and updating corresponding fields in the first record according to the first topic; and if there is the topic reply information under the first topic, updating corresponding fields in the first record according to the topic reply information of the first topic.

In some embodiments, when the first record is created, it may first generate an empty first record having one or more fields, and then acquire content of corresponding fields from the first topic to write the content into the corresponding fields in the first record. The first record has fields corresponding to the topic information, as well as fields corresponding to the topic reply information, so that if there is the topic reply information of the first topic under the first topic, the fields therein will also be updated correspondingly according to the topic reply information. By recording, in one record, the fields corresponding to the first topic and the fields corresponding to the topic reply information of the first topic, an association relation between the first topic and the topic reply information thereof is better presented, facilitating the user to view the two in association when searching for the content from the first document.

In some embodiments of the present disclosure, the method further comprises: after generating, in the first document, the first record corresponding to the first topic, replying to the first topic to inform that the first topic has been recorded. In some embodiments, the first topic may be replied to by the chatbot, thereby generating the topic reply information to inform that the first topic has been recorded, such that a situation where the record fails to be generated due to software failure or another reason but the user thinks that the record has been generated may be avoided, and the case of not generating the record can be found in time.

In some embodiments of the present disclosure, a second record in the first document corresponds to a second topic in the first group, and the method further comprises: in response to generating new topic reply information under the second topic in the first group, updating corresponding fields in the second record according to the newly generated topic reply information.

In some embodiments, the second record may be any record in the first document, for example, may be the first record, or may be any record in other embodiments of the present disclosure; one record may have a plurality of fields, which may include the fields corresponding to the topic information and the fields corresponding to the topic reply information; and, after the new topic reply information is generated under the second topic, the topic reply information is recorded in the record of the corresponding topic information, and the corresponding fields are updated. In this way, the topic information and its corresponding topic reply information can be known by one record, reflecting the association thereof.

In some embodiments of the present disclosure, the record in the first document comprises at least one of: a topic time field, a topic content field, a topic attachment field, a reply content field, a reply attachment field, a topic creator field, a topic group name field, a follower field, a completion time field, a completion period field, a status field, or a status updater field.

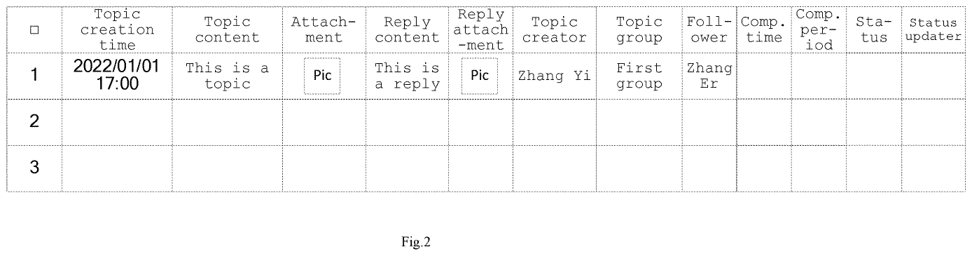

In some embodiments, reference may be made to FIG. 2, which schematically illustrates a format of one record in a first document, where a topic time field is used for recording a topic creation time, a topic content field is used for recording content in a topic, a topic attachment field is used for storing an attachment in topic information, a reply content field is used for recording content of topic reply information, a reply attachment field is used for storing an attachment in the topic reply information, a topic creator field is used for recording a poster of the topic information, a topic group name field is used for recording a group in which the topic information is located, a follower field is used for recording a poster of the topic reply information, a completion time field is used for recording a completion time when the topic information is a task or announcement to be completed, a completion period field is used for recording a time spent on the completion, a status field is used for recording a status of the topic information, for example, Completed and Incomplete, and a status updater field is used for recording a person changing the status of the topic information, for example, Zhang San has completed the topic information, such that the status information is changed from Incomplete to Completed, and at this time the status updater is Zhang San.

In some embodiments of the present disclosure, a third record in the first document corresponds to a third topic in the first group, and the method further comprises: in response to the third topic in the first group being withdrawn, performing at least one of: changing the status field in the third record in the first document to a first preset content; changing the reply content field corresponding to topic reply information of the third topic to a second preset content; or changing the topic content field in the third record to a third preset content.

In some embodiments, the information in the group may be withdrawn after being sent, and the status of the topic information needs to be correspondingly changed after the topic information is withdrawn; and the first preset content, the second preset content, and the third preset content may be, for example, “Withdrawn”; such that the change in the topic information is reflected by the change in the record, which also avoids the leakage of the withdrawn content, caused by the content of the topic information or the topic reply information being still recorded in the first document after the topic information or the topic reply information is withdrawn.

In some embodiments of the present disclosure, a fourth record in the first document corresponds to a fourth topic in the first group, and the method further comprises: in response to a change operation on the status field of the fourth record in the first document, sending topic reply information of the fourth topic in the first group by the chatbot, wherein the sent topic reply information of the fourth topic comprises: the status field in the fourth record, or, the status field in the fourth record and an operator performing the change operation.

In some embodiments, the fourth record may be any record of the present disclosure, for example, may be the first record, the second record, or the third record, and in some embodiments, a status of the corresponding topic information may be changed by a status of the record in the first document, for example, by changing, in the fourth record, the status field to Completed, thereby completing the fourth topic. When the user modifies the status field in the first document, it is possible to record, by the chatbot, the user performing the change operation, then determine a position of the fourth topic by a link of topic information in the fourth record, and then reply to the fourth topic with the changed status by the chatbot in a manner of replying to the topic information, and the reply content may be “changed status” and @ the user performing the change operation, such that participants in the first group that is related to the fourth topic can know the change in the status of the fourth topic in time and can know it without opening the first document, meanwhile the convenience of the use is also improved because the status can be changed in the first document.

In some embodiments of the present disclosure, before the in response to generating first information which mentions a chatbot in a first group, the method further comprises: determining a setting state of the first group, the setting state comprising a first state and a second state. In the case where the setting state of the first group is the first state, if new information is generated in the first group, the records in the first document are updated according to the generated new information; and in the case where the setting state of the first group is the second state, the steps of determining, in response to generating the first information which mentions the chatbot in the first group, the first topic in which the first information is located and generating the corresponding first record in the first document according to the first topic in which the first information is located are performed.

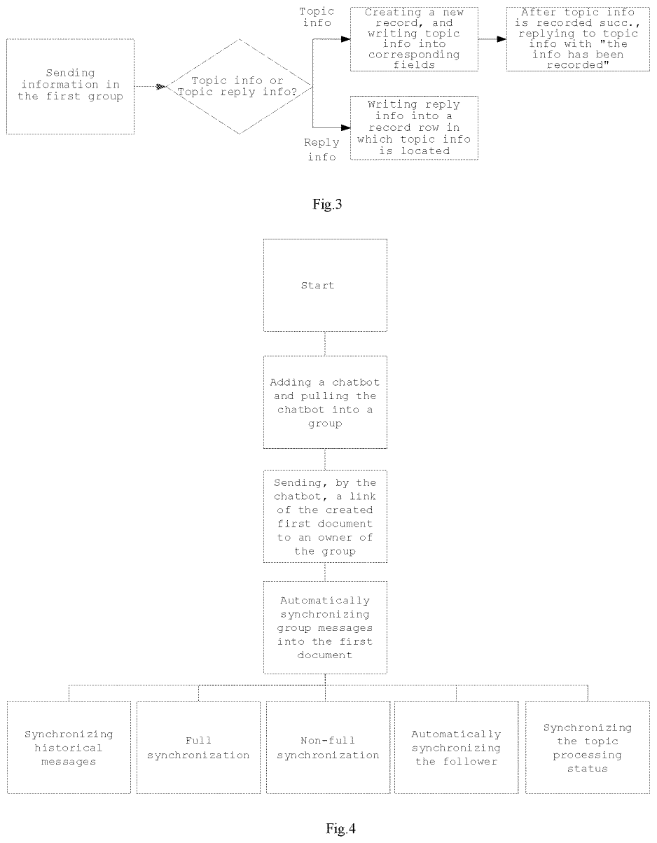

In some embodiments, the manner of recording the information of the first group into the first document may be divided into full synchronization and non-full synchronization, wherein for the full synchronization which corresponds to the first state, at this time, as long as there is a user who sends one piece of information in the first group, the information is recorded into the first document; specifically, referring to FIG. 3, after new information is detected, it may be determined whether it is topic information or topic reply information. If it is the topic information, a new record is created, and the topic information is recorded into corresponding fields, and after the recording succeeds, a reply of “the information has been recorded” is made under the topic information; and if it is the topic reply information, the topic reply information is recorded into a record of the corresponding topic information, specifically, for example, into a reply content field. However, for the non-full synchronization which corresponds to the second state, at this time, only when the user mentions the chatbot in the topic information or the topic reply information, the record corresponding to the topic information is generated, thereby recording the specific content.

In some embodiments of the present disclosure, the method further comprises: according to pre-set settings, determining whether to synchronize historical information of the first group; and if it is determined to synchronize the historical information of the first group, generating corresponding records in the first document according to the historical information of the first group.

In some embodiments, the step of generating the record of the topic information in the first document may be performed by the chatbot. Before or after the chatbot is added into the first group, it can be set whether the historical information of the first group needs to be recorded into the first document, if so, the records corresponding to the historical information are generated in the first document, otherwise, the records corresponding to the historical information are not generated in the first document. In some embodiments, a time period of the historical information to be recorded may be set, for example, it may be set that historical information within a longest period of nearly one year may be acquired, and corresponding records may be generated.

In some embodiments of the present disclosure, before the in response to generating first information which mentions a chatbot in a first group, the method further comprises at least one of: pulling the chatbot into the first group; creating the first document and associating the first group with the first document; or, sending a link of the first document to a group owner of the first group, or to a group owner and group members of the first group. In some embodiments, since the chatbot needs to be mentioned, the chatbot needs to be pulled into the first group, and similarly, an association relation between the first group and the first document needs to be pre-established. Moreover, in order that the members in the first group can find the recorded first document, the link of the first document needs to be sent to the group owner or to both the group owner and the members in the first group.

In some embodiments of the present disclosure, the creating the first document comprises: creating the first document according to a document template. In some embodiments of the present disclosure, the associating the first group with the first document comprises at least one of: writing a corresponding relation between group information of the first group and document information of the first document into a configuration document, setting an owner of the first document as the group owner of the first group, or sending the link of the first document to the group owner of the first group by the chatbot.

In some embodiments, the configuration document is preset, which is used for recording the association relation between the group and the document; one document may be associated with one group, and may also be associated with a plurality of groups; the group information of the first group may include, for example, a group ID, the document information of the first document may include, for example, a document ID of the first document, and if there are a plurality of forms in the first document, the document information may further include a form ID in the first document for storing the records. In some embodiments, since the information of the first group is recorded in the first document, the group owner of the first group may be the owner of the first document by default.

In some embodiments of the present disclosure, an owner of the first document is a group owner of the first group, and when the group owner of the first group is changed, the original group owner of the first group is reminded to transfer ownership of the first document. In some embodiments, since the first document has recorded therein the information in the first group, the group owner of the first group is the owner of the first document by default, and after the group owner of the first group is changed, information may be sent by the chatbot to the original group owner before the change, to remind him to transfer the ownership of the first document to the new group owner after the change as needed.

In some embodiments of the present disclosure, the method further comprises: in response to a fifth topic corresponding to a fifth record in the first document having topic reply information, determining a sender of the topic reply information of the fifth topic; and if the sender of the topic reply information of the fifth topic is not a sender of the fifth topic, writing the sender of the topic reply information of the fifth topic into a follower field of the fifth record.

In some embodiments, the fifth record may be any record of the present disclosure, such as the first record, the second record, the third record, or the fourth record. When the fifth topic has the topic reply information, it is indicated that there is a user participating in the fifth topic, and if the user participating in the fifth topic is not the sender of the fifth topic, it is indicated that he follows the fifth topic, so that he is recorded into the follower field of the fifth topic.

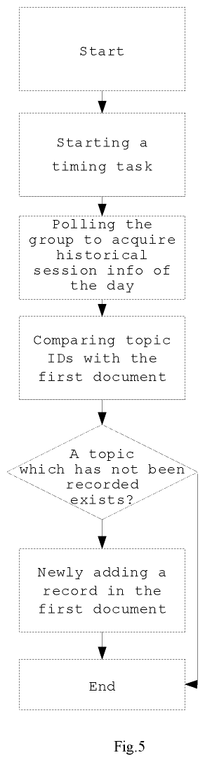

In some embodiments, the method in some embodiments of the present disclosure is described in conjunction with FIG. 4, where after a first group is created, a chatbot is added to the first group, and then the chatbot may create an association relation between a first document and the first group and send a link of the first document to a group owner of the first group. Afterwards, the step of synchronizing information in the first group into the first document is performed, that is, the step of generating records according to the information in the first group; specifically, it is possible to, according to pre-set settings, determine whether it is needed to generate records in the first document according to historical information of the first group, and whether to adopt full synchronization or non-full synchronization; and, when the full synchronization is adopted, all the information generated in the first group is used for updating the record in the first group, and when the non-full synchronization is adopted, only topic information in which information where the chatbot is mentioned is located is used for generating a record, and the fields in the record are updated using topic reply information of the topic information. When there is a user replying to the topic information with the corresponding record, the user is recorded as a follower of the topic information; by performing a change operation on a status field in the record, a status of the topic information can be changed, and reply information is sent to the topic information and an operator of the change operation is mentioned in the reply information.

In some embodiments of the present disclosure, the method further comprises: in response to reaching a preset time point, acquiring information generated in the first group within a past preset time period (such as the day); comparing the information generated in the first group within the past preset time period with the records in the first document; and if there is information which should be recorded but has not been recorded in the information generated in the first group within the past preset time period, updating the first document.

In some embodiments, when it is detected that new information is generated in the first group, updating the records in the first document is triggered, but due to network fluctuation and other reasons, new information (for example, the information mentioning the chatbot) may not be recorded in the first document although generated in the first group, so that a preset time point of each day may be set, information of the current whole day is acquired at the preset time point, and a comparison operation is performed; as shown in FIG. 5, IDs of the topic information may be compared with the records in the first document, and if there is topic information or reply information of the topic information which should be recorded but has not been recorded, the records in the first document are updated correspondingly, thereby ensuring the integrity of the records.

In some embodiments of the present disclosure, the method further comprises: determining whether a number of records in the first document reaches a preset value; if the number of the records in the first document reaches the preset value, creating a copy of the first document; and emptying the records in the first document.

In some embodiments, there is an upper limit in the number of the records that can be stored in the first document, so that when the number of the generated records does not reach the preset value, the records are normally generated in the first document, and if the number of the records in the first document reaches the preset value, a copy of the first document is created in a preset document space that is pre-configured, which may be named, for example, “group”+“archive”+“date”, and the copy of the first document is archived into the preset document space. Then, the records in the first document are deleted. Because the copy of the first document is created and the first document is emptied, for the first group, the first document associated with it has been always unchanged, there is no change in its configuration information such as the link for storing the information and like, so that there are no permission and other problems, and since the information in the first group is stored always using the first document, there are no new problems.

In some embodiments of the present disclosure, the method further comprises: determining an owner of the first document, and transferring ownership of the copy of the first document to the owner of the first document. In some embodiments, since the copy of the first document is used for recording the information of the first group, its owner is set to be the same as that of the first document, ensuring that there is no permission problem when searching for the record.

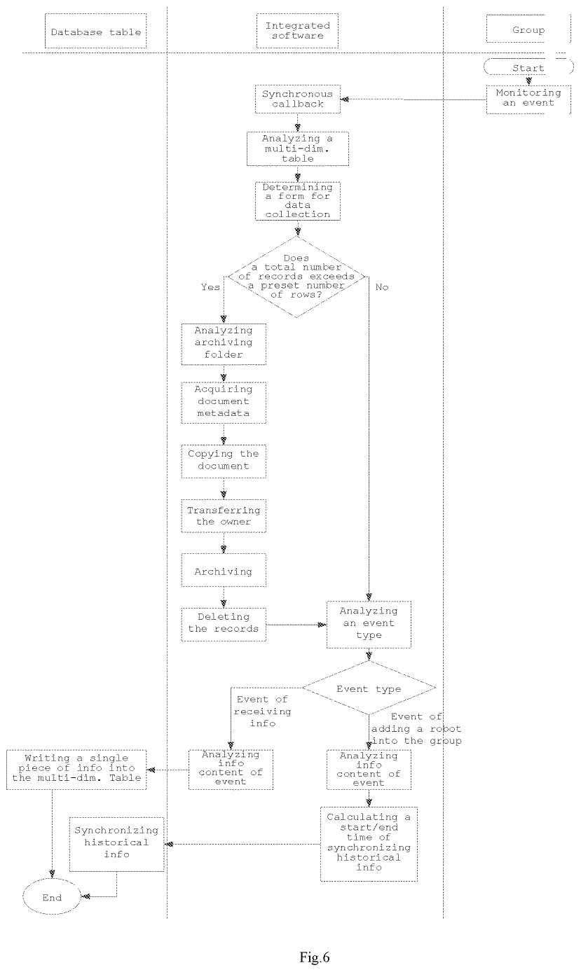

In some embodiments, please refer to FIG. 6, where in this embodiment, taking an example that a first document is a database table, interactions among a first group, integrated software, and the database table (the first document) are shown, wherein the integrated software may be part of the method execution party in the embodiment of the present disclosure. It is monitored in the first group whether an event is generated, for example, whether there is new information, and if an event is generated, the integrated software is notified; the integrated software will perform synchronous callback to the first group to inform that the notification has been received, then the integrated software will analyze the multi-dimensional table to determine a form of records in the multi-dimensional table that corresponds to the first group; and, if a total number of the records exceeds a preset number of rows (a preset value), it will analyze the first document to acquire metadata thereof, and generate a copy of the first document, transfer ownership of the copy of the first document to a group owner of the first group, and then archive the copy of the first document, and then delete the records in the first document. Then, it analyzes a type of the monitored event, if the event type is that the chatbot is added into the first group, it determines whether to synchronize historical information according to pre-set settings, and if the historical information is to be synchronized, it determines a start and end time of synchronizing the historical information, and synchronizes the historical information within the period of time, that is, generating corresponding records in the first document according to the historical information within the period of time. If the event type is that the information has been received, the information content will be analyzed, and a record will be generated or an existing record will be updated in the first document according to the information.

The present disclosure further provides an information processing apparatus, comprising:
a detecting unit configured to, in response to generating first information which mentions a chatbot in a first group, determine a first topic in which the first information is located, wherein the first information is topic information or topic reply information; and
a processing unit configured to generate a corresponding first record in a first document according to the first topic in which the first information is located,
wherein the first group is associated with the first document.

In some embodiments, the generating a corresponding first record in a first document according to the first topic in which the first information is located comprises:
creating the first record in the first document, and updating corresponding fields in the first record according to the first topic; and
if there is the topic reply information under the first topic, updating corresponding fields in the first record according to the topic reply information of the first topic.

In some embodiments, the processing unit is further configured to: after generating, in the first document, the first record corresponding to the first topic, replying to the first topic to inform that the first topic has been recorded.

In some embodiments, a second record in the first document corresponds to a second topic in the first group, and the processing unit is further configured to: in response to generating new topic reply information under the second topic in the first group, update corresponding fields in the second record according to the newly generated topic reply information.

In some embodiments, the record in the first document comprises at least one of: a topic time field, a topic content field, a topic attachment field, a reply content field, a reply attachment field, a topic creator field, a topic group name field, a follower field, a completion time field, a completion period field, a status field, or a status updater field.

In some embodiments, a third record in the first document corresponds to a third topic in the first group, and the processing unit is further configured to: in response to the third topic in the first group being withdrawn, perform at least one of:
changing the status field in the third record in the first document to a first preset content;
changing the reply content field corresponding to topic reply information of the third topic to a second preset content; or
changing the topic content field in the third record to a third preset content.

In some embodiments, a fourth record in the first document corresponds to a fourth topic in the first group, and the processing unit is further configured to: in response to a change operation on the status field of the fourth record in the first document, send topic reply information of the fourth topic in the first group by the chatbot, wherein the sent topic reply information of the fourth topic comprises: the status field in the fourth record, or, the status field in the fourth record and an operator performing the change operation.

In some embodiments, the processing unit is further configured to: before the in response to generating first information which mentions a chatbot in a first group, determine a setting state of the first group, the setting state comprising a first state and a second state;
in the case where the setting state of the first group is the first state, if new information is generated in the first group, update the records in the first document according to the generated new information; and
in the case where the setting state of the first group is the second state, perform the steps of determining, in response to generating the first information which mentions the chatbot in the first group, the first topic in which the first information is located and generating the corresponding first record in the first document according to the first topic in which the first information is located.

In some embodiments, the processing unit is further configured to: according to pre-set settings, determine whether to synchronize historical information of the first group; and
if it is determined to synchronize the historical information of the first group, generate corresponding records in the first document according to the historical information of the first group.

In some embodiments, before the in response to generating first information which mentions a chatbot in a first group, the processing unit is further configured to achieve at least one of:
pulling the chatbot into the first group;
creating the first document and associating the first group with the first document; or
sending a link of the first document to a group owner of the first group, or to a group owner and group members of the first group.

In some embodiments, the creating the first document comprises: creating the first document according to a document template; and/or
the associating the first group with the first document comprises at least one of: writing a corresponding relation between group information of the first group and document information of the first document into a configuration document, setting an owner of the first document as the group owner of the first group, or sending the link of the first document to the group owner of the first group by the chatbot.

In some embodiments, an owner of the first document is a group owner of the first group, and when the group owner of the first group is changed, the original group owner of the first group is reminded to transfer ownership of the first document.

In some embodiments, the processing unit is further configured to: in response to a fifth topic corresponding to a fifth record in the first document having topic reply information, determine a sender of the topic reply information of the fifth topic; and
if the sender of the topic reply information of the fifth topic is not a sender of the fifth topic, write the sender of the topic reply information of the fifth topic into a follower field of the fifth record.

In some embodiments, the processing unit is further configured to: in response to reaching a preset time point, acquire information generated in the first group within a past preset time period;
compare the information generated in the first group within the past preset time period with the records in the first document; and
if there is information which should be recorded but has not been recorded in the information generated in the first group within the past preset time period, update the first document.

In some embodiments, the processing unit is further configured to: determine whether a number of records in the first document reaches a preset value;
if the number of the records in the first document reaches the preset value, create a copy of the first document; and
empty the records in the first document.

In some embodiments, the processing unit is further configured to achieving at least one of:
determining an owner of the first document, and transferring ownership of the copy of the first document to the owner of the first document; or
archiving the copy of the first document into a preset document space.

For the embodiments of the apparatus, since they substantially correspond to the method embodiments, reference is made to the description of the method embodiments for relevant points. The apparatus embodiments described above are merely illustrative, wherein the modules described as separate modules may or may not be separate. Some or all of the modules may be selected according to actual needs to achieve the purpose of the solution of this embodiment. One of ordinary skill in the art can understand and implement them without paying creative labor.

The method and apparatus of the present disclosure have been described above based on the embodiments and application examples. In addition, the present disclosure also provides an electronic device and a storage medium, which are described below.

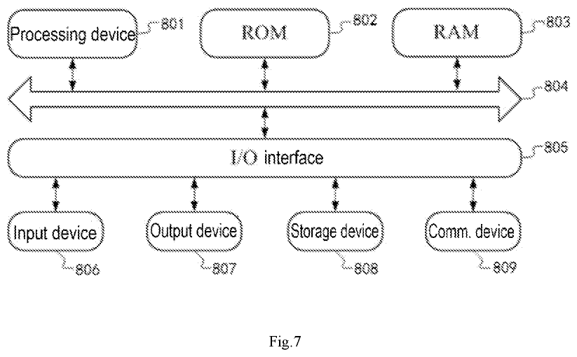

Referring to FIG. 7 below, it illustrates a schematic structural diagram of an electronic device (e.g., a terminal device or server) 800 suitable for implementing the embodiments of the present disclosure. The terminal device in the embodiments of the present disclosure may include, but is not limited to, a mobile terminal such as a mobile phone, a laptop, a digital broadcast receiver, a PDA (Personal Digital Assistant), a PAD (tablet), a PMP (Portable Multimedia Player), a vehicle-mounted terminal (e.g., a vehicle-mounted navigation terminal), and the like, and a fixed terminal such as a digital TV, a desktop, and the like. The electronic device shown in the figure is only an example and should not bring any limitation to the functions and the scope of use of the embodiments of the present disclosure.

As shown in FIG. 7, the electronic device 800 may include a processing device (e.g., a central processing unit, graphics processing unit, etc.) 801 that may perform various appropriate actions and processes according to a program stored in a read-only memory (ROM) 802 or a program loaded from a storage device 808 into a random access memory (RAM) 803. In the RAM 803, various programs and data required for the operation of the electronic device 800 are also stored. The processing device 801, the ROM 802, and the RAM 803 are connected to each other by a bus 804. An input/output (I/O) interface 805 is also connected to the bus 804.

Generally, the following device may be connected to the I/O interface 805: an input device 806 including, for example, a touch screen, touch pad, keyboard, mouse, camera, microphone, accelerometer, gyroscope, etc.; an output device 807 including, for example, a liquid crystal display (LCD), speaker, vibrator, etc.; the storage device 808 including, for example, a magnetic tape, hard disk, etc.; and a communication device 809. The communication device 809 may allow the electronic device 800 to communicate wirelessly or by wire with other devices to exchange data. While the electronic device 800 with various devices is shown in the figure, it should be understood that not all illustrated devices are required to be implemented or provided. More or fewer devices may be alternatively implemented or provided.

In particular, according to the embodiment of the present disclosure, the processes described above with reference to the flow diagrams may be implemented as a computer software program. For example, the embodiment of the present disclosure comprises a computer program product comprising a computer program carried on a computer-readable medium, the computer program comprising program codes for performing the method illustrated by the flow diagrams. In such an embodiment, the computer program may be downloaded and installed from a network via the communication device 809, or installed from the storage device 808, or installed from the ROM 802. The computer program, when executed by the processing device 801, performs the above functions defined in the method of the embodiment of the present disclosure.

It should be noted that the above non-transitory computer-readable medium of the present disclosure may be a computer-readable signal medium or a computer-readable storage medium or any combination of the above two. The computer-readable storage medium may be, for example, but is not limited to, an electronic, magnetic, optical, electromagnetic, infrared, or semiconductor system, apparatus, or device, or any combination of the foregoing. More specific examples of the computer-readable storage medium may include, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer-readable storage medium may be any tangible medium containing or storing a program, wherein the program can be used by or in conjunction with an instruction execution system, apparatus, or device. However, in the present disclosure, the computer-readable signal medium may include a data signal propagated in baseband or as part of a carrier wave, in which computer-readable program codes are carried. Such a propagated data signal may take a variety of forms, including, but not limited to, an electromagnetic signal, optical signal, or any suitable combination of the forgoing. The computer-readable signal medium may also be any computer-readable medium other than the computer-readable storage medium, wherein the computer-readable signal medium can send, propagate, or transmit a program for use by or in conjunction with an instruction execution system, apparatus, or device. The program codes contained on the computer-readable medium may be transmitted using any appropriate medium, including but not limited to: a wire, an optical cable, RF (Radio Frequency), etc., or any suitable combination of the foregoing.

In some embodiments, a client and a server may communicate using any currently known or future developed network protocol, such as HTTP (HyperText Transfer Protocol), and may be interconnected with any form or medium of digital data communication (e.g., a communication network). Examples of the communication network include a local area network (“LAN”), a wide area network (“WAN”), an internet (e.g., the Internet), and a peer-to-peer network (e.g., an ad hoc peer-to-peer network), as well as any currently known or future developed network.

The above computer-readable medium may be contained in the above electronic device; or may exist separately without being assembled into the electronic device.

The above computer-readable medium has one or more programs carried thereon, wherein the above one or more programs, when executed by the electronic device, cause the electronic device to perform the above method of the present disclosure.

Computer program codes for performing the operation of the present disclosure may be written in one or more programming languages or a combination thereof, wherein the above programming language includes an object-oriented programming language such as Java, Smalltalk, and C++, and also includes a conventional procedural programming language, such as a “C” language or a similar programming language. The program codes may be executed entirely on a user's computer, partly on a user's computer, as a stand-alone software package, partly on a user's computer and partly on a remote computer, or entirely on a remote computer or server. In a scenario where a remote computer is involved, the remote computer may be connected to a user's computer through any type of network, including a local area network (LAN) or a wide area network (WAN), or may be connected to an external computer (for example, through the Internet using an Internet service provider).

The flow diagrams and block diagrams in the drawings illustrate the possibly implemented architecture, functions, and operations of the system, method and computer program product according to various embodiments of the present disclosure. In this regard, each block in the flow diagrams or block diagrams may represent a module, program segment, or portion of codes, which includes one or more executable instructions for implementing a specified logical function. It should also be noted that, in some alternative implementations, functions noted in blocks may occur in a different order from those noted in the drawings. For example, two blocks shown in succession may, in fact, be executed substantially concurrently, or they may sometimes be executed in a reverse order, which depends upon the functions involved. It will also be noted that each block in the block diagrams and/or flow diagrams, and a combination of the blocks in the block diagrams and/or flow diagrams, can be implemented by a special-purpose hardware-based system that performs specified functions or operations, or by a combination of special-purpose hardware and computer instructions.

The involved units described in the embodiments of the present disclosure may be implemented by software or hardware. The name of the unit does not, in some cases, constitute a limitation on the unit itself.

The functions described above herein may be executed, at least partially, by one or more hardware logic components. For example, without limitation, a hardware logic component of an exemplary type that may be used includes: a field programmable gate array (FPGA), an application specific integrated circuit (ASIC), an application specific standard parts (ASSP), a system on chip (SOC), a complex programmable logic device (CPLD), and the like.

In the context of this disclosure, a machine-readable medium may be a tangible medium, which can contain or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium include an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

According to one or more embodiments of the present disclosure, there is provided an information processing method, comprising:
in response to generating first information which mentions a chatbot in a first group, determining a first topic in which the first information is located, wherein the first information is topic information or topic reply information; and
generating a corresponding first record in a first document according to the first topic in which the first information is located,
wherein the first group is associated with the first document.

According to one or more embodiments of the present disclosure, there is provided an information processing method, wherein the generating a corresponding first record in a first document according to the first topic in which the first information is located comprises:
creating the first record in the first document, and updating corresponding fields in the first record according to the first topic; and
if there is the topic reply information under the first topic, updating corresponding fields in the first record according to the topic reply information of the first topic.

According to one or more embodiments of the present disclosure, there is provided an information processing method, further comprising: after generating, in the first document, the first record corresponding to the first topic, replying to the first topic to inform that the first topic has been recorded.

According to one or more embodiments of the present disclosure, there is provided an information processing method, wherein a second record in the first document corresponds to a second topic in the first group, and the method further comprises:
in response to generating new topic reply information under the second topic in the first group, updating corresponding fields in the second record according to the newly generated topic reply information.

According to one or more embodiments of the present disclosure, there is provided an information processing method, wherein the record in the first document comprises at least one of: a topic time field, a topic content field, a topic attachment field, a reply content field, a reply attachment field, a topic creator field, a topic group name field, a follower field, a completion time field, a completion period field, a status field, or a status updater field.

According to one or more embodiments of the present disclosure, there is provided an information processing method, wherein a third record in the first document corresponds to a third topic in the first group, and the method further comprises: in response to the third topic in the first group being withdrawn, performing at least one of:
changing the status field in the third record in the first document to a first preset content;
changing the reply content field corresponding to topic reply information of the third topic to a second preset content; or
changing the topic content field in the third record to a third preset content.

According to one or more embodiments of the present disclosure, there is provided an information processing method, wherein a fourth record in the first document corresponds to a fourth topic in the first group, and the method further comprises:
in response to a change operation on the status field of the fourth record in the first document, sending topic reply information of the fourth topic in the first group by the chatbot, wherein the sent topic reply information of the fourth topic comprises: the status field in the fourth record, or, the status field in the fourth record and an operator performing the change operation.

According to one or more embodiments of the present disclosure, there is provided an information processing method, wherein before the in response to generating first information which mentions a chatbot in a first group, the method further comprises:
determining a setting state of the first group, the setting state comprising a first state and a second state;
in the case where the setting state of the first group is the first state, if new information is generated in the first group, updating the records in the first document according to the generated new information; and
in the case where the setting state of the first group is the second state, performing the steps of determining, in response to generating the first information which mentions the chatbot in the first group, the first topic in which the first information is located and generating the corresponding first record in the first document according to the first topic in which the first information is located.

According to one or more embodiments of the present disclosure, there is provided an information processing method, further comprising: according to pre-set settings, determining whether to synchronize historical information of the first group; and
if it is determined to synchronize the historical information of the first group, generating corresponding records in the first document according to the historical information of the first group.

According to one or more embodiments of the present disclosure, there is provided an information processing method, wherein before the in response to generating first information which mentions a chatbot in a first group, the method further comprises at least one of:
pulling the chatbot into the first group;
creating the first document and associating the first group with the first document; or
sending a link of the first document to a group owner of the first group, or to a group owner and group members of the first group.

According to one or more embodiments of the present disclosure, there is provided an information processing method, wherein the creating the first document comprising: creating the first document according to a document template; and/or
the associating the first group with the first document comprises at least one of: writing a corresponding relation between group information of the first group and document information of the first document into a configuration document, setting an owner of the first document as the group owner of the first group, or sending the link of the first document to the group owner of the first group by the chatbot.

According to one or more embodiments of the present disclosure, there is provided an information processing method, wherein an owner of the first document is a group owner of the first group, and when the group owner of the first group is changed, the original group owner of the first group is reminded to transfer ownership of the first document.

According to one or more embodiments of the present disclosure, there is provided an information processing method, further comprising:
in response to a fifth topic corresponding to a fifth record in the first document having topic reply information, determining a sender of the topic reply information of the fifth topic; and
if the sender of the topic reply information of the fifth topic is not a sender of the fifth topic, writing the sender of the topic reply information of the fifth topic into a follower field of the fifth record.

According to one or more embodiments of the present disclosure, there is provided an information processing method, further comprising:
in response to reaching a preset time point, acquiring information generated in the first group within a past preset time period;
comparing the information generated in the first group within the past preset time period with the records in the first document; and
if there is information which should be recorded but has not been recorded in the information generated in the first group within the past preset time period, updating the first document.

According to one or more embodiments of the present disclosure, there is provided an information processing method, further comprising:
determining whether a number of records in the first document reaches a preset value;
if the number of the records in the first document reaches the preset value, creating a copy of the first document;
emptying the records in the first document.

According to one or more embodiments of the present disclosure, there is provided an information processing method, further comprising at least one of:
determining an owner of the first document, and transferring ownership of the copy of the first document to the owner of the first document; or
archiving the copy of the first document into a preset document space.

According to one or more embodiments of the present disclosure, there is provided an information processing apparatus, comprising:
a detecting unit configured to, in response to generating first information which mentions a chatbot in a first group, determine a first topic in which the first information is located, wherein the first information is topic information or topic reply information; and
a processing unit configured to generate a corresponding first record in a first document according to the first topic in which the first information is located,
wherein the first group is associated with the first document.

According to one or more embodiments of the present disclosure, there is provided an electronic device, comprising: at least one memory and at least one processor,
wherein the at least one memory is configured to store program codes and the at least one processor is configured to call the program codes stored in the at least one memory to perform the method according to any of the above.

According to one or more embodiments of the present disclosure, there is provided a non-transitory computer-readable storage medium for storing program codes which, when executed by a computer, cause the computer to perform the method according to any of the above.

According to one or more embodiments of the present disclosure, there is provided a computer program which, when executed by a processor, implements the method according to any of the above.

The foregoing description is only illustration of the preferred embodiments of the present disclosure and the technical principles employed. It should be appreciated by those skilled in the art that the disclosure scope involved in the present disclosure is not limited to the technical solutions formed by specific combinations of the above technical features, but also encompasses other technical solutions formed by arbitrary combinations of the above technical features or equivalent features thereof without departing from the above disclosed concepts. For example, a technical solution formed by performing mutual replacement between the above features and technical features having similar functions to those disclosed (but not limited to) in the present disclosure.

Furthermore, while operations are depicted in a specific order, this should not be understood as requiring that these operations be performed in the specific order shown or in a sequential order. Under certain circumstances, multitasking and parallel processing might be advantageous. Similarly, while several specific implementation details are included in the above discussion, these should not be construed as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or method logical actions, it should be understood that the subject matter defined in the attached claims is not necessarily limited to the specific features or actions described above. Rather, the specific features and actions described above are only example forms of implementing the claims.

1. An information processing method, comprising:
in response to generating first information which mentions a chatbot in a first group, determining a first topic in which the first information is located, wherein the first information is topic information or topic reply information; and
generating a corresponding first record in a first document according to the first topic in which the first information is located,
wherein the first group is associated with the first document.

2. The method according to claim 1, wherein the generating a corresponding first record in a first document according to the first topic in which the first information is located comprises:
creating the first record in the first document, and updating corresponding fields in the first record according to the first topic; and
if there is the topic reply information under the first topic, updating corresponding fields in the first record according to the topic reply information of the first topic.

3. The method according to claim 2, further comprising: after generating, in the first document, the first record corresponding to the first topic, replying to the first topic to inform that the first topic has been recorded.

4. The method according to claim 1, wherein a second record in the first document corresponds to a second topic in the first group, and the method further comprises:
in response to generating new topic reply information under the second topic in the first group, updating corresponding fields in the second record according to the newly generated topic reply information.

5. The method according to claim 1, wherein
the record in the first document comprises at least one of: a topic time field, a topic content field, a topic attachment field, a reply content field, a reply attachment field, a topic creator field, a topic group name field, a follower field, a completion time field, a completion period field, a status field, or a status updater field.

6. The method according to claim 5, wherein a third record in the first document corresponds to a third topic in the first group, and the method further comprises: in response to the third topic in the first group being withdrawn, performing at least one of:
changing the status field in the third record in the first document to a first preset content;
changing the reply content field corresponding to topic reply information of the third topic to a second preset content; or
changing the topic content field in the third record to a third preset content.

7. The method according to claim 5, wherein a fourth record in the first document corresponds to a fourth topic in the first group, and the method further comprises:
in response to a change operation on the status field of the fourth record in the first document, sending topic reply information of the fourth topic in the first group by the chatbot, wherein the sent topic reply information of the fourth topic comprises: the status field in the fourth record, or, the status field in the fourth record and an operator performing the change operation.

8. The method according to claim 1, wherein before the in response to generating first information which mentions a chatbot in a first group, the method further comprises:
determining a setting state of the first group, the setting state comprising a first state and a second state;
in response to the setting state of the first group being the first state, if new information is generated in the first group, updating the records in the first document according to the generated new information; and
in response to the setting state of the first group being the second state, performing the steps of determining, in response to generating the first information which mentions the chatbot in the first group, the first topic in which the first information is located and generating the corresponding first record in the first document according to the first topic in which the first information is located.

9. The method according to claim 1, further comprising:
according to pre-set settings, determining whether to synchronize historical information of the first group; and
if it is determined to synchronize the historical information of the first group, generating corresponding records in the first document according to the historical information of the first group.

10. The method according to claim 1, wherein before the in response to generating first information which mentions a chatbot in a first group, the method further comprises at least one of:
pulling the chatbot into the first group;
creating the first document and associating the first group with the first document; or
sending a link of the first document to a group owner of the first group, or to a group owner and group members of the first group.

11. The method according to claim 10, wherein at least one of the following is achieved:
the creating the first document comprises: creating the first document according to a document template; or
the associating the first group with the first document comprises at least one of: writing a corresponding relation between group information of the first group and document information of the first document into a configuration document, setting an owner of the first document as the group owner of the first group, or sending the link of the first document to the group owner of the first group by the chatbot.

12. The method according to claim 1, wherein
an owner of the first document is a group owner of the first group, and when the group owner of the first group is changed, the original group owner of the first group is reminded to transfer ownership of the first document.

13. The method according to claim 1, further comprising:
in response to a fifth topic corresponding to a fifth record in the first document having topic reply information, determining a sender of the topic reply information of the fifth topic; and
if the sender of the topic reply information of the fifth topic is not a sender of the fifth topic, writing the sender of the topic reply information of the fifth topic into a follower field of the fifth record.

14. The method according to claim 1, further comprising:
in response to reaching a preset time point, acquiring information generated in the first group within a past preset time period;
comparing the information generated in the first group within the past preset time period with the records in the first document; and
if there is information which should be recorded but has not been recorded in the information generated in the first group within the past preset time period, updating the first document.

15. The method according to claim 1, further comprising:
determining whether a number of records in the first document reaches a preset value;
if the number of the records in the first document reaches the preset value, creating a copy of the first document; and
emptying the records in the first document.

16. The method according to claim 15, further comprising at least one of:
determining an owner of the first document, and transferring ownership of the copy of the first document to the owner of the first document; or
archiving the copy of the first document into a preset document space.

17. (canceled)

18. An electronic device, comprising:
at least one memory and at least one processor,
wherein the at least one memory is configured to store program codes, and the at least one processor is configured to call the program codes stored in the at least one memory to perform the following information processing operations:
in response to generating first information which mentions a chatbot in a first group, determining a first topic in which the first information is located, wherein the first information is topic information or topic reply information; and
generating a corresponding first record in a first document according to the first topic in which the first information is located,
wherein the first group is associated with the first document.

19. A non-transitory computer-readable storage medium for storing program codes which, when executed by a computer, cause the computer to perform the following information processing operations:
in response to generating first information which mentions a chatbot in a first group, determining a first topic in which the first information is located, wherein the first information is topic information or topic reply information; and
generating a corresponding first record in a first document according to the first topic in which the first information is located,
wherein the first group is associated with the first document.

20. (canceled)

21. The electronic device according to claim 18, wherein the generating a corresponding first record in a first document according to the first topic in which the first information is located comprises:
creating the first record in the first document, and updating corresponding fields in the first record according to the first topic; and
if there is the topic reply information under the first topic, updating corresponding fields in the first record according to the topic reply information of the first topic.

22. The storage medium according to claim 19, wherein the generating a corresponding first record in a first document according to the first topic in which the first information is located comprises:
creating the first record in the first document, and updating corresponding fields in the first record according to the first topic; and
if there is the topic reply information under the first topic, updating corresponding fields in the first record according to the topic reply information of the first topic.
